(19) United States
(12) Patent Application Publication
(10) Pub. No.: US 2025/0197752 A1
(43) Pub. Date: Jun. 19, 2025

(54) PROCESS AND/OR FACILITY INTEGRATION OF ANAEROBIC DIGESTION OF ONE OR MORE STILLAGE COMPOSITIONS

(71) Applicant: POET Research, Inc., Sioux Falls, SD (US)

(72) Inventors: David Charles Carlson, Brandon, SD (US); Ryan Wood, Sioux Falls, SD (US); Brady Christopher Clavel, Yankton, SD (US)

(21) Appl. No.: 18/978,387

(22) Filed: Dec. 12, 2024

Related U.S. Application Data
(60) Provisional application No. 63/610,725, filed on Dec. 15, 2023.

(51) Int. Cl. C10L 3/10; B01D 1/26; B01D 3/00; B01D 3/40; C12F 3/06

(52) U.S. Cl. CPC C10L 3/105; B01D 1/26; B01D 3/001; B01D 3/40; C12F 3/06; C10L 2290/543

(57) ABSTRACT

A bioprocessing facility that includes an anaerobic digestion system configured to receive and digest a composition to produce a biogas and an anaerobic digestion digestate composition; an ammonia distillation system in fluid communication with the anaerobic digestion digestate composition; at least one evaporator; and a distillation system configured to receive at least a portion of thermal energy from the vapor composition produced by the at least one evaporator to heat at least a portion of contents in the distillation system. The anaerobic digestion digestate composition includes a first concentration o ammonia. The evaporator is configured to receive the vapor composition from the ammonia distillation system as a heat source to heat a feed in the evaporator and form a vapor composition and a concentrated liquid. The distillation system is configured to separate a biochemical from a fermented composition. Related methods of producing biogas from a stillage composition.

### CROSS-REFERENCE TO RELATED APPLICATION

This nonprovisional patent application claims the benefit of U.S. Provisional Patent Application Ser. No. 63/610,725, filed on Dec. 15, 2023, wherein said provisional patent application is incorporated herein by reference in its entirety.

### BACKGROUND

The present disclosure relates to methods and systems that produce stillage compositions and using one or more stillage compositions as feed for anaerobic digestion.

There is a continuing need for new and improved methods and/or systems for incorporating anaerobic digestion into bioprocessing facilities that produce stillage compositions.

### SUMMARY

Embodiments of the present disclosure include a bioprocessing facility that includes a source of one or more stillage compositions; an anaerobic digestion system configured to receive and digest at least a portion of the one or more stillage compositions to produce a biogas and an anaerobic digestion digestate composition; an ammonia distillation system in fluid communication with at least a portion of the anaerobic digestion digestate composition; at least one evaporator; and a distillation system configured to receive at least a portion of thermal energy directly or indirectly from the vapor composition produced by the at least one evaporator to heat at least a portion of contents in the distillation system. The anaerobic digestion digestate composition includes a first concentration of ammonia. The ammonia distillation system is configured to form at least a first concentrated anaerobic digestion digestate composition including a second concentration of ammonia that is less than the first concentration of ammonia, and a vapor composition including ammonia. The at least one evaporator is configured to receive at least a portion of the vapor composition from the ammonia distillation system as a heat source to heat a feed in the at least one evaporator and form a vapor composition and a concentrated liquid. The distillation system is configured to separate at least one biochemical from a fermented composition.

Embodiments of the present disclosure also include a method of producing biogas from one or more stillage compositions. The method includes exposing at least a portion of at least one stillage composition to anaerobic digestion conditions to produce a biogas and an anaerobic digestion digestate composition; introducing at least a portion of the anaerobic digestion digestate composition as feed into an ammonia distillation system to form at least a first concentrated anaerobic digestion digestate composition and a vapor composition; introducing at least a portion of the vapor composition from the ammonia distillation system into at least one evaporator as a heat source to heat a feed in the at least one evaporator and form a vapor composition and a concentrated liquid; and using at least a portion of thermal energy in the vapor composition produced by the at least one evaporator to heat at least a portion of contents in a distillation system. The anaerobic digestion digestate composition comprises a first concentration of ammonia. The first concentrated anaerobic digestion digestate composition includes a second concentration of ammonia that is less than the first concentration of ammonia. The vapor composition includes ammonia. The distillation system is configured to separate at least one biochemical from a fermented composition.

### BRIEF DESCRIPTION OF THE DRAWINGS

Various examples of the present disclosure will be discussed with reference to the appended drawings. These drawings depict only illustrative examples of the disclosure and are not to be considered limiting of its scope.

FIG. 1 is a schematic showing an illustrative embodiment of a bioprocessing facility that generates stillage compositions from beer;

FIG. 2 illustrates a non-limiting embodiment according to the present disclosure of incorporating anaerobic digestion into the bioprocessing facility 100 shown in FIG. 1;

FIG. 3 illustrates another non-limiting embodiment according to the present disclosure of incorporating anaerobic digestion into the bioprocessing facility 100 shown in FIG. 1;

FIG. 4 illustrates another non-limiting embodiment according to the present disclosure of incorporating anaerobic digestion into the bioprocessing facility 100 shown in FIG. 1; and

FIG. 5 illustrates another non-limiting embodiment according to the present disclosure of incorporating anaerobic digestion into the bioprocessing facility 100 shown in FIG. 1.

### DETAILED DESCRIPTION

The present disclosure relates to integrating one or more anaerobic digestion systems into a bioprocessing facility that produces one or more stillage compositions as a byproduct/co-product. As used herein, a “bioprocessing facility” refers to a facility that can produce one or more bioproducts by converting biomass feedstock via one or more physical processes, one or more chemical processes, one or more bioprocesses, and combinations thereof. Non-limiting examples of bioprocessing facilities include dry mills, wet mills, biofuel production facilities, pharmaceutical production facilities, soy processing facilities, breweries, bakeries, and the like.

A bioproduct refers to a product derived from a biological, renewable resource. For example, a bioproduct can be a component of biomass feedstock (e.g., grain feedstock) that is liberated from the biomass feedstock (e.g., grain oil such as corn oil from corn grain) and/or can include a chemical (“biochemical” or “target biochemical”) that is produced by a biocatalyst (e.g., microorganism and/or enzyme) such as, for example, alcohol produced by yeast fermenting sugar. Non-limiting examples of bioproducts produced in a bioprocessing facility include one or more of fuel, feed, food, pharmaceuticals, beverages and precursor chemicals. In some embodiments, a bioproduct includes, among others, one or more monomeric sugars, one or more enzymes, one or more oils, one or more alcohols (e.g., ethanol, butanol, and the like), fungal biomass, amino acids, and one or more organic acids (e.g., lactic acid), and combinations thereof.

In some embodiments, one or more bioprocesses are carried out in a bioprocessing facility utilizing living cells (one or more microorganisms) and/or their components (e.g., enzymes produced by a microorganism) to obtain a desired bioproduct. Non-limiting examples of bioprocesses include one or more of hydrolysis (e.g., enzymatic hydrolysis), aerobic fermentation, or anaerobic fermentation. In some embodiments, a bioprocess includes saccharification and fermentation of a plant-based feedstock into a biofuel via enzymatic hydrolysis and yeast-based fermentation of the hydrolysate (e.g., yeast-based fermentation in a grain-to-ethanol biofuel facility).

One or more bioproducts can be separated from beer to form at least one target bioproduct stream (e.g., ethanol) and one or more co-product streams (e.g., whole stillage). A co-product stream can encompass any stillage composition downstream from fermentation after separating one or more bioproducts from beer using one or more thermal-based separation technologies such as distillation, evaporation, and the like. As used herein, a “stillage composition” can include whole stillage, at least one stillage composition derived from whole stillage, and combinations thereof. Non-limiting examples of a stillage composition derived from whole stillage include wet cake, thin stillage, concentrated thin stillage (syrup), defatted syrup, defatted emulsion, clarified thin stillage, distiller's oil, distiller's grain, distiller's yeast, and the like. Non-limiting examples of methods and systems for processing stillage streams are also described in U.S. Pat. No. 8,702,819 (Bootsma); U.S. Pat. No. 9,061,987 (Bootsma); U.S. Pat. No. 9,290,728 (Bootsma); U.S. Pat. No. 10,059,966 (Bootsma); U.S. Pat. No. 11,248,197 (Bootsma); and U.S. Pub. No. 2020/0140899 (Bootsma); wherein the entirety of each of said patent documents is incorporated herein by reference.

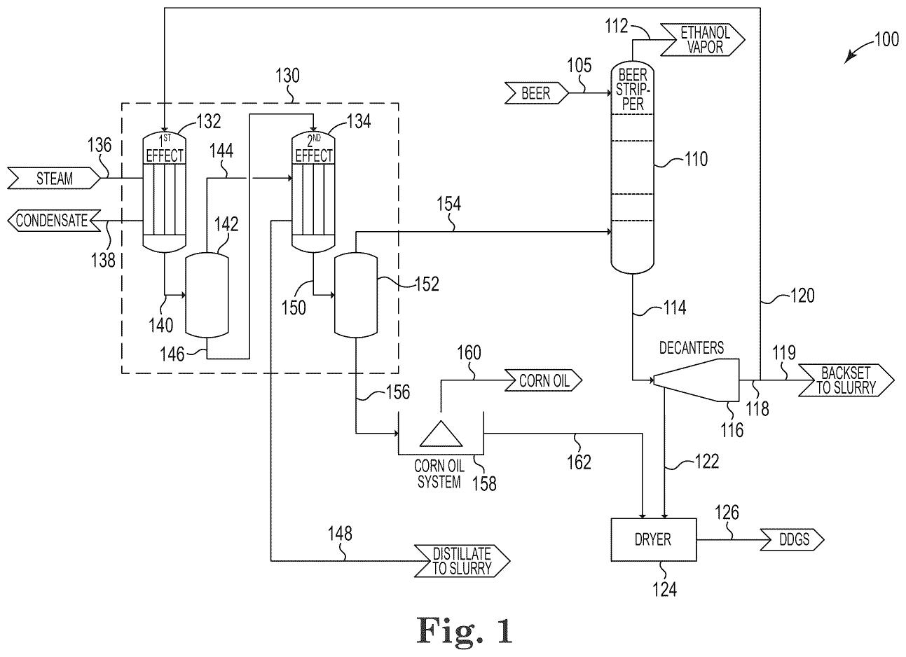

FIG. 1 shows a non-limiting example of a bioprocessing facility 100 that forms a beer 105, e.g., in a dry-grind corn ethanol bioprocessing facility. As shown in FIG. 1, bioprocessing facility 100 produces ethanol as a biochemical 112 that is separated from beer 105 via a distillation system 110 to produce whole stillage 114. FIG. 1 shows the distillation column of distillation system 110, which can also include a reflux section (not shown) and a reboiler portion (not shown). Whole stillage is separated in separation system 116 into thin stillage 118 and wet cake 122. Separation system can include a wide variety of one or more solid-liquid separators to separate whole stillage into thin stillage 118 and wet cake 122. Non-limiting examples of solid-liquid separators include one or more centrifuges (e.g., two-phase vertical disk-stack centrifuge, three-phase vertical disk-stack centrifuge, filtration centrifuge), one or more decanters (e.g., filtration decanters), one or more filters (e.g., fiber filter, rotary vacuum drum filter, filter device having one or more membrane filters), one or more screen devices (e.g., a “DSM” screen; one or more pressure screens; one or more paddle screens; one or more rotary drum screens; one or more centrifugal screeners; one or more linear motion screens; one or more vacu-deck screen; etc.), one or more brush strainers, one or more vibratory separators, one or more hydrocyclones, and combinations thereof. As shown in FIG. 1, separation system 116 includes one or more decanters.

As shown, a portion 120 of thin stillage 118 is sent to be concentrated in a multi-effect evaporator system 130. Optionally, a portion 119 portion of thin stillage 118 can be recycled upstream as backset to form a slurry of ground corn for fermentation (not shown).

A multi-effect evaporator system includes two or more evaporators in series operating at different pressures such that the vapor generated in one of the effects can be used as a heat source and condense in the subsequent effect. In this way a multi-effect evaporator system can perform a continuous evaporation on an initial “feed” stream to concentrate the feed stream. It is noted that one or more evaporators could be included in a multi-effect evaporator system to operate as multiple stages of evaporators in parallel with a given “effect” evaporator. One non-limiting example of an evaporator is a falling film evaporator, which includes a vertical shell and tube heat exchanger. A liquid feed stream can be continuously recirculated to the top of the “tube side” and form a film on the inner surface of the tube as it falls from the top to the bottom under the force of gravity. Each evaporator has a vapor stream as a heat source that enters on the “shell side” of the evaporator to transfers heat to a feed stream that is fed on a “tube side” of the evaporator. The vapor stream indirectly heats the feed stream such that the vapor stream at least partially condenses to form a condensate. An “effect” is defined as operating at a given boiling temperature of the feed stream to concentrate the feed stream. For example, a stillage composition can be fed to an evaporator of a given “effect” to form a concentrated stillage composition. A downstream “effect” evaporator, or subsequent “effect” evaporator (e.g., “final-effect evaporator) operates a lower boing temperature (e.g., by operating at a lower pressure). Likewise a subsequent “effect” evaporator can concentrate the stream that is fed to it. The heating section of an evaporator may be the same or separate from the vapor/liquid separation section. As shown in FIGS. 1-5, the heating section is separate from a flash tank where vapor/liquid separation occurs.

In more detail, portion 120 is fed as feed to the tube side of a first-effect evaporator 132, which is heated via a stream of steam 136 on the shell side of first-effect evaporator 132. Portion 120 is heated by steam 136, which condenses into condensate 138. Heated thin stillage 140 is sent to flash tank 142 so that it can separate into vapor composition 144 and partially, concentrated thin stillage 146. A portion of the concentrated thin stillage 146 may optionally be recirculated to the inlet of the first effect evaporator 132 to maintain sufficient liquid flow through the evaporator (not shown). The concentrated thin stillage 146 is sent to the tube side of final-effect evaporator 134 (which is a second-effect evaporator in this embodiment) and the vapor composition 144 is fed as a heat source to the shell side of final-effect evaporator 134. The partially, concentrated thin stillage 146 is heated by vapor composition 144, which condenses into condensate 148. As shown, condensate 148 (also referred to as distillate) can be recycled upstream to form a slurry with ground corn for fermentation. The heated, partially, concentrated thin stillage 150 is sent to flash tank 152 so that it can separate into vapor composition 154 and concentrated thin stillage 156. As shown in FIG. 1, the vapor composition 154 is introduced into the bottom “stripping” section of distillation column of distillation system 110 to provide heat to distillation system 110.

A portion of the concentrated thin stillage 156 may optionally be recirculated to the inlet of the second effect evaporator 134 to maintain sufficient liquid flow through the evaporator (not shown). The concentrated thin stillage 156 can be sent to a separator system 158 to separate corn oil 160 and defatted thin stillage 162 from concentrated thin stillage 156.

As shown in FIG. 1, wet cake 122 and defatted thin stillage are combined and dried in dryer system 124 to form dried distillers' grain with solubles (DDGS) 126.

According to the present disclosure an anaerobic digestion system is incorporated into a bioprocessing facility, such as a dry-grind corn facility, to use one or more stillage compositions as feed to form biogas. Advantageously, the anaerobic digestion system can be incorporated in a manner that manages one or more of energy balance and/or water balance of the bioprocessing facility while at the same time managing ammonia that is produced during anaerobic digestion so that it does not impact one or more processes or bioproducts of the bioprocessing facility.

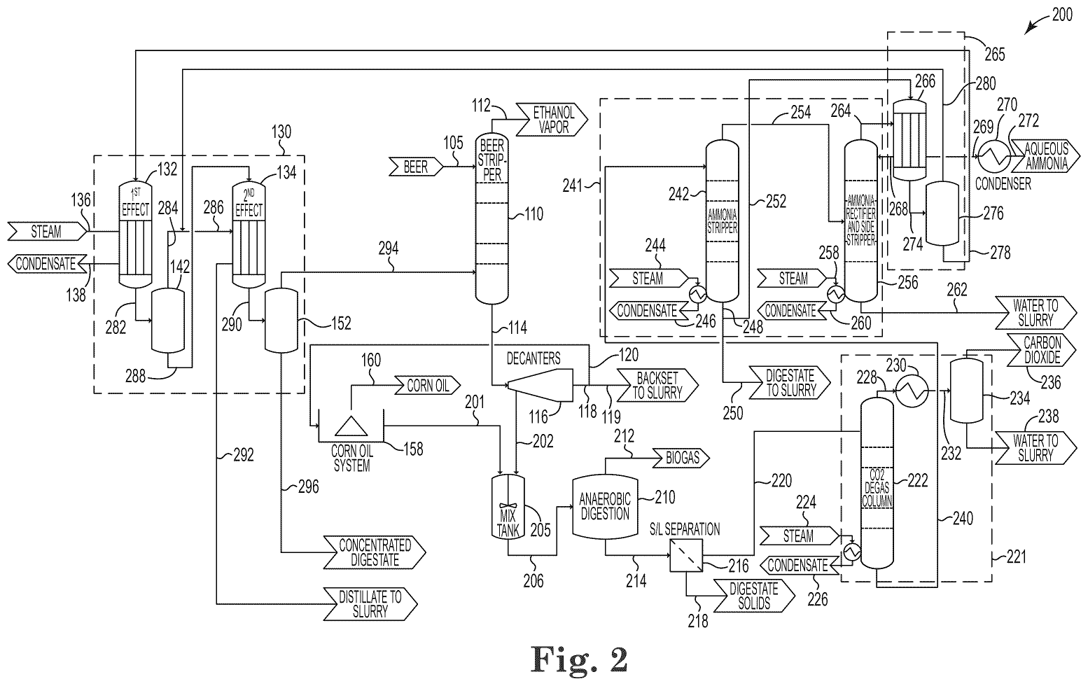

FIGS. 2-5 each illustrate non-limiting embodiments according to the present disclosure of incorporating anaerobic digestion into the bioprocessing facility 100 shown in FIG. 1. Reference characters discussed above with respect to FIG. 1 may be repeated in one or more of FIGS. 2-5 to illustrate the same or similar system or process stream as shown in FIG. 1. Reference characters repeated in any of FIGS. 2-5 may or may not be discussed again. Likewise, reference characters first discussed in any of FIGS. 2-5 may or may not be repeated in any of FIGS. 2-5, and repeated reference characters may or may not be discussed again.

As described below, the bioprocessing facility incorporates anaerobic digestion of whole stillage in a manner that recycles energy and water in bioprocessing facility 200 while at the same time managing ammonia produced in anaerobic digestion relative to recycling process streams in the bioprocessing facility for water and/or energy balance purposes.

As shown in FIG. 2, portion 120 of thin stillage 118 is sent to separator system 158 to separate corn oil 160 and defatted thin stillage 201 from portion 120 of thin stillage 118 instead of being concentrated first in an evaporation system (e.g., like evaporation system 130 in FIG. 1).

Removing corn oil before anaerobic digestion can reduce or mitigate inhibition caused by corn oil during anaerobic digestion. Also, in some embodiments, separating corn oil permits it to be sold as a higher-value co-product instead of being converted to biogas. It is noted that because portion 120 of thin stillage 118 is not first concentrated like concentrated thin stillage 254 in FIG. 1, portion 120 may have a relatively higher flow rate to the separator system 158.

The defatted, thin stillage 201 is mixed with the wet cake 202 from the decanters of the separation system 116 in mix tank 205, and the mixture (aka “defatted whole stillage”) 206 is fed to the anaerobic digestion system 210, where it is exposed to anaerobic digestion conditions. The anaerobic digestion system 210 is configured to digest at least a portion of the mixture 206 to produce a biogas 212 and an anaerobic digestion digestate composition 214.

A separation system 216 is in fluid communication with the anaerobic digestion digestate composition 214 and is configured to separate the anaerobic digestion digestate composition 214 into at least an anaerobic digestion liquid effluent 220 and an anaerobic digestion solid effluent 218. The anaerobic digestion solid effluent 218, which includes most of the suspended solids in the anaerobic digestion digestate composition 214, can be applied to land in some embodiments if desired.

Optionally, as shown in FIG. 2, at least a portion of anaerobic digestion liquid effluent 220 can be sent to a carbon-dioxide degasification system 221. Sending anaerobic digestion liquid effluent 220 to carbon-dioxide degasification system 221 can remove substantially all of the dissolved carbon-dioxide gas but leave the ammonia in the degassed, anaerobic digestion liquid effluent 240 (e.g., column bottoms). A non-limiting example of a carbon-dioxide degasification system includes a distillation column. As shown in FIG. 2, carbon-dioxide degasification system 221 includes at least distillation column 222. Anaerobic digestion liquid effluent 220 is fed to distillation column 222 and thermal energy is introduced into at least the bottom of distillation column 222 so that a portion of the contents of distillation column 222 can be heated to form a vapor composition 228 and degassed, anaerobic digestion liquid effluent 240. As shown in FIG. 2, steam is used as heat source 224 to heat the contents in inside distillation column 222 and form a condensate 226. The vapor composition 228 includes carbon-dioxide gas and water vapor. The vapor composition 228 can be cooled in condenser 230 and the cooled stream 232 can be fed to a flash tank 234, where carbon dioxide 236 is separated from liquid water 238. If desired, at least a portion of liquid water 238 can be recycled upstream to form a slurry with feedstock (e.g., ground corn) for fermentation. It is noted that if optional carbon-dioxide degasification system 221 is not included in bioprocessing facility 200, condensate 272 (discussed below), would include predominately ammonium carbonate and ammonium bicarbonate product instead of an aqueous ammonia.

As shown in FIG. 2, the degassed, anaerobic digestion liquid effluent 240 is sent to an ammonia distillation system 241 that includes a main stripper 242 and a rectifier/side stripper 256. The three outlet streams from the ammonia distillation system 241 and that are derived from the degassed, anaerobic digestion liquid effluent 240 are ammonia-stripped anaerobic digestion liquid effluent 248 from the bottom of the main stripper 242, water 262 from the bottom of the rectifier/side stripper 256, and aqueous ammonia vapor 264 from the top of the rectifier/side stripper 256.

A portion 250 of the ammonia-stripped anaerobic digestion liquid effluent 248 is optionally recycled upstream to form a slurry with feedstock (e.g., ground corn) for fermentation. This may be done in place of or in addition to portion 119 of thin stillage 118 being sent to slurry as backset. Due to the high temperature of and the liquid residence time within the main stripper 242 a subsequent biological kill step is not necessary for this configuration.

Water 262 is optionally recycled upstream to form a slurry with feedstock (e.g., ground corn) for fermentation.

In some embodiments, the ammonia distillation system 241 may include only two columns (ammonia stripper and ammonia rectifier), however in this configuration ammonia-stripped anaerobic digestion liquid effluent 248 from the bottom of the main stripper 242 would likely be more relatively more dilute, which may require additional evaporation in order to reach the same solid content target.

In some embodiments, the ammonia distillation system 241 may include only one column (ammonia stripper), however in this configuration the condensate 272 (an ammonia product such as either aqueous ammonia or ammonium carbonate and ammonium bicarbonate mixture) would likely be significantly more dilute and require larger systems for storage and/or disposal.

A variety of sources of thermal energy can be used for ammonia distillation system 241. As shown for illustration purposes, a stream of steam 244 is used for main stripper 242 and forms condensate 246 through the process of transferring heat to the contents of main stripper 242. Likewise, a stream of steam 258 is used for rectifier/side stripper 256 and forms condensate 260 through the process of transferring heat to the contents of rectifier/side stripper 256.

According to the present disclosure, energy from an ammonia distillation system can be captured to help manage the energy balance of the bioprocessing facility that the ammonia distillation system is incorporated into as result of using one or more stillage compositions as feed streams to anaerobic digestion. At the same time the water balance of the bioprocessing facility can be managed. Also, because ammonia distillation system removes ammonia, capturing energy from an ammonia distillation system can be accomplished in a manner that does not impact one or more processes or bioproducts of the bioprocessing facility due to ammonia that is produced during anaerobic digestion.

An example of capturing energy from an ammonia distillation system to help manage the energy balance of the bioprocessing facility that the ammonia distillation system is incorporated into is illustrated in FIG. 2 with evaporator system 265 and multi-effect evaporator system 130. It is noted that evaporator system 265 could be a multi-effect evaporator system, if desired.

As shown in FIG. 2, ammonia distillation system 241 can be operated under pressure such that energy from condensing aqueous ammonia vapor 264 from the top of the rectifier/side stripper 256 can be utilized as a heat source to evaporate water from a feed stream to evaporator 266 and form a vapor composition and a concentrated liquid. The thermal energy captured in the vapor composition from evaporator 266 can then be used to heat distillation system 110 while at the same time recovering process water, if desired. As shown in FIG. 2, portion 252 of the ammonia-stripped anaerobic digestion liquid effluent 248 from the bottom of the main stripper 242 can be used as the feed for evaporator 266 in evaporator system 265, where portion 252 is concentrated. The heated, portion 274 is sent to flash tank 276 so that it can separate into vapor composition 280 and concentrated ammonia-stripped anaerobic digestion liquid effluent 278.

The evaporator 266 can operate as a partial condenser such that all of the liquid 268 that condenses is returned to the rectifier portion of rectifier/side stripper 256 as reflux and the aqueous ammonia product 269 is entirely vapor that is condensed in a subsequent condenser 270 that operates at a lower temperature and forms condensate 272. Condensate 272 can be sold as a fertilizer if desired.

Concentrated ammonia-stripped anaerobic digestion liquid effluent 278 is further concentrated in multi-effect evaporator system 130 while vapor composition 280 is used as a heat source in multi-effect evaporator system 130. A multi-effect evaporator system includes at least one effect evaporator prior to the final-effect evaporator 134 that is configured to receive concentrated ammonia-stripped anaerobic digestion liquid effluent 278 as feed. As shown in FIG. 2, evaporator system 130 is a two-effect evaporator system, where final-effect evaporator 134 is a second-effect evaporator. Alternatively, final-effect evaporator 134 could be a third-effect, fourth-effect, etc. evaporator depending on the desired number of “effects” for the multi-effect evaporator system. For example, managing the water balance of a bioprocessing facility such as bioprocessing facility 200 can influence the number of “effects” selected.

As illustrated in FIG. 2, concentrated ammonia-stripped anaerobic digestion liquid effluent 278 is fed to first-effect evaporator 132 where it is further concentrated. The heated, portion 282 is sent to flash tank 142 so that it can separate into vapor composition 284 and further concentrated ammonia-stripped anaerobic digestion liquid effluent 288.

In some embodiments, it can be desirable to introduce vapor composition 280 into evaporator system 130 as close to the front of the evaporator system 130 as possible to begin using the thermal energy present in vapor composition 280. Although ammonia distillation system 241 is expected to essentially remove all of the ammonia such that no undue amount of ammonia remains in concentrated ammonia-stripped anaerobic digestion liquid effluent 278 and/or vapor composition 280, the vapor composition 280 is introduced into second-effect evaporator 134. Introducing vapor composition 280 into second-effect evaporator 134 instead of combining it with steam 136 from the boiler of bioprocessing facility 200 can prevent any undue amount of ammonia that could enter the boiler system.

Alternatively, if the vapor composition 280 is at the right temperature and pressure, it may be able to completely replace (not shown) steam 136. For example, vapor composition 280 could be used in this manner if aqueous ammonia vapor 264 is at a pressure from 0-50 psig, or even 10-20 psig (e.g., 15 psig) at saturated vapor temperature for the given pressure. Vapor composition could then be at a pressure from −5-50 psig, or even −5 to 15 psig, at saturated vapor temperature for the given pressure.

Referring back to the bioprocessing facility 200 illustrated in FIG. 2, vapor composition 280 is combined with vapor composition 284 produced in the first-effect evaporator 132 to form vapor composition 286, which is sent to the shell side of the second-effect evaporator 134, which is the final-effect evaporator in the embodiment of multi-effect evaporator system 130 illustrated. If multi-effect evaporator system 130 includes additional effect evaporators (e.g., third effect, fourth effect, etc.) it may still be desirable to introduce at least a portion (e.g., all) of the vapor composition into the second-effect evaporator 134, as explained above. Vapor composition 286 is condensed on the shell of the final-effect evaporator 134 as condensate 292. In some embodiments, at least a portion of condensate 292 can be recycled upstream to form a slurry with feedstock (e.g., ground corn) for fermentation.

Concentrated ammonia-stripped anaerobic digestion liquid effluent 288 is introduced as feed into the final-effect evaporator 134, which is a second-effect evaporator in this embodiment, and further concentrated. The heated, portion 290 is sent to flash tank 152 so that it can separate into vapor composition 294 and further concentrated ammonia-stripped anaerobic digestion liquid effluent 296. Because ammonia has been removed from the degassed, anaerobic digestion liquid effluent 240 in the ammonia distillation system 241 there is relatively little to essentially no ammonia present in the vapor composition 294 from final-effect evaporator 134 that is injected in the distillation system 110.

As can be seen, the thermal energy in vapor composition 280 from ammonia distillation system 241 can be captured and used elsewhere in the bioprocessing facility while at the same time recovering process water, if desired, to be elsewhere in bioprocessing facility 200. This way, the energy and water balances of bioprocessing facility 200 can still be managed even though one or more stillage compositions are used as feed streams for anaerobic digestion, which produces ammonia that can impact one or more processes to an undue degree if not managed appropriately. Also, process water can be recovered from concentrated ammonia-stripped anaerobic digestion liquid effluent 278 to help manage water balance.

The further concentrated ammonia-stripped anaerobic digestion liquid effluent 296 is expected to contain phosphorus (P) and potassium (K). In some embodiments, the further concentrated ammonia-stripped anaerobic digestion liquid effluent 296 is stored and land applied as a fertilizer. Also, condensate 272 is expected to contain nitrogen (N). If desired, the condensate 272 could be combined with the further concentrated ammonia-stripped anaerobic digestion liquid effluent 296 to form a fertilizer.

In some embodiments, where the anaerobic digestion solid effluent 218 and/or the concentrated anaerobic digestion liquid effluent 296 have a relatively high solids content, there may be a relatively higher volumetric flowrate of condensate 292 as compared to condensate 148. In some embodiments, the volumetric flowrate of condensate 292 may by more than the slurry system in front end of bioprocessing facility 200 is capable of using. In these cases, a portion of condensate 292 may be processed through additional unit operations (such as RO membrane filtration, aerobic digestion treatment, or potentially no additional unit operations) and/or used as makeup water in the cooling tower.

As an alternative, the evaporator system 265 could be eliminated and the aqueous ammonia vapor 264 could be introduced on the shell side of first-effect evaporator 132 instead of steam 136 from the boiler system. The temperature and/or pressure of the aqueous ammonia vapor 264 may be adjusted via the ammonia distillation system 241 if desired to accommodate this alternative embodiment.

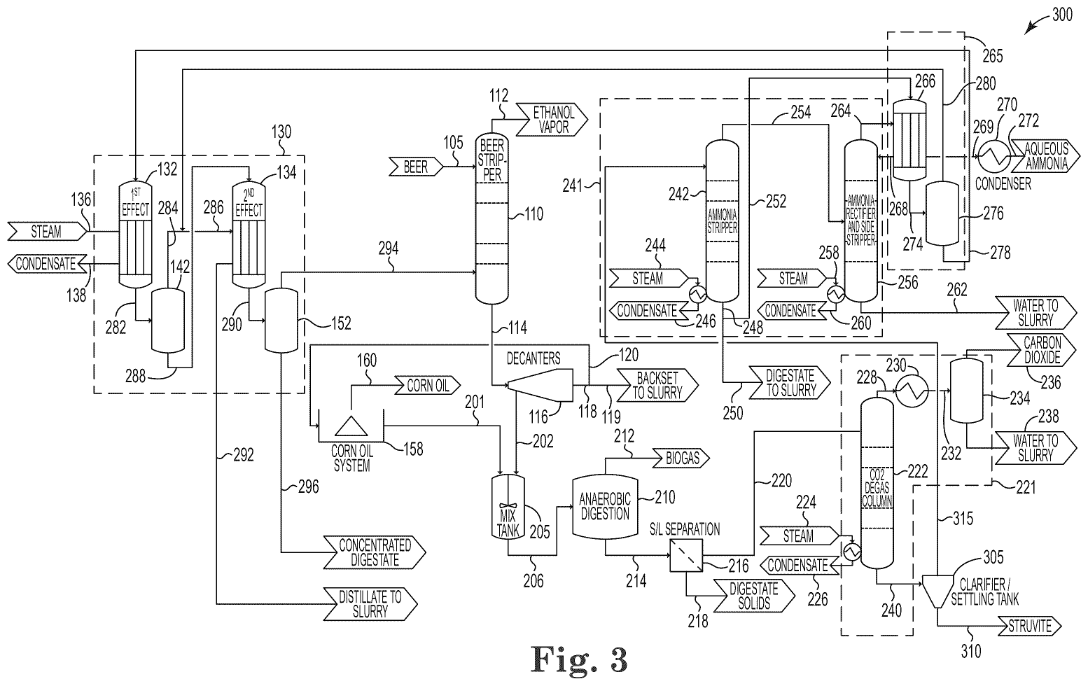

FIG. 3 shows an alternative bioprocessing facility 300 that incorporates anaerobic digestion. Bioprocessing facility 300 is similar to bioprocessing facility 200 in FIG. 2, described above, except that a mineral removal process is included after the carbon-dioxide degasification system 221. Removing the carbon dioxide from the anaerobic digestion liquid effluent 220 tends to increase the pH of the degassed, anaerobic digestion liquid effluent 240 and tends to cause conditions favorable for precipitation of one or more minerals (e.g., struvite=magnesium ammonium phosphate) that can be removed from the degassed, anaerobic digestion liquid effluent 240 by using separation system 305 to separate degassed, anaerobic digestion liquid effluent 240 into clarified, degassed, anaerobic digestion liquid effluent 315 and struvite 310. Non-limiting examples of separation techniques used in separation system 305 includes one or more of settling by gravity, membrane separation, centrifuge, and the like. This struvite removal step may optionally or alternatively be configured before the carbon-dioxide degasification system 221 and/or after the main stripper 242 and may optionally include a pH adjustment step or addition of a magnesium supplement to aid in struvite precipitation.

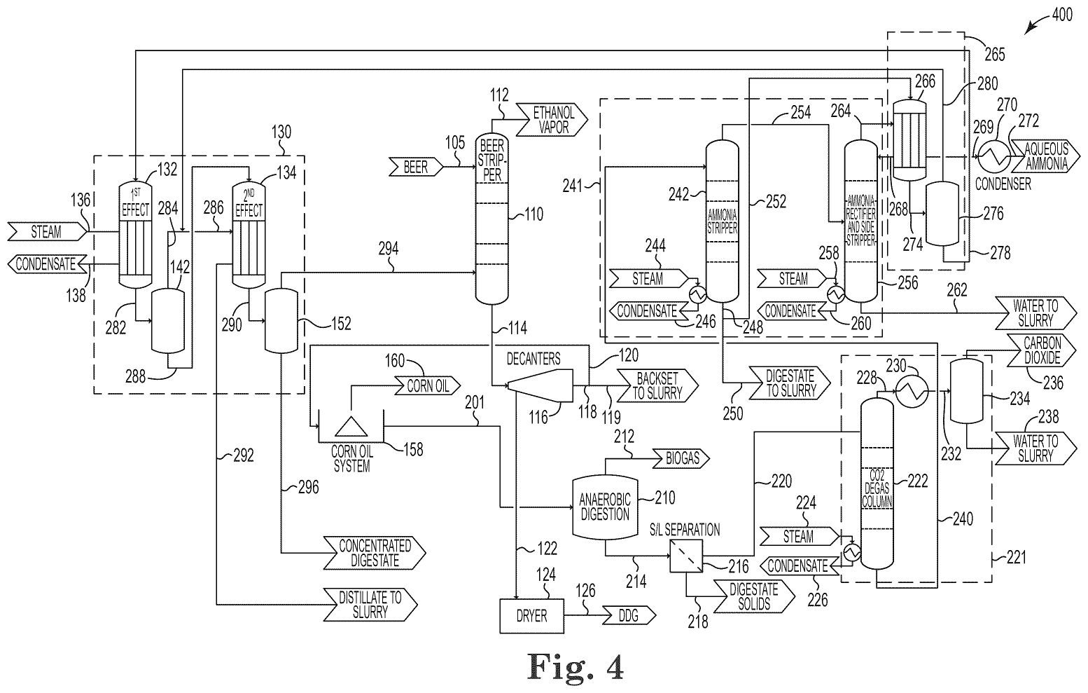

FIG. 4 shows an alternative bioprocessing facility 400 that incorporates anaerobic digestion. Bioprocessing facility 400 is similar to bioprocessing facility 200 in FIG. 2, described above, except that wet cake 122 is dried in dryer system 124 to produce dried distillers' grain (DDG) 126 instead of being sent to mix tank 205 and anaerobic digestion system 210. It is noted that because wet cake is not sent to anaerobic digestion system 210, the feed to anaerobic digestion system 210 may have lower total solids, especially lower suspended solids. In some embodiments, because of the lower solids being fed to anaerobic digestion system 210, a separation system 216 may not be needed to separate anaerobic digestion digestate composition 214 and the anaerobic digestion digestate composition 214, or fraction thereof, may be sent to optional carbon-dioxide degasification system 221 and/or ammonia distillation system 241.

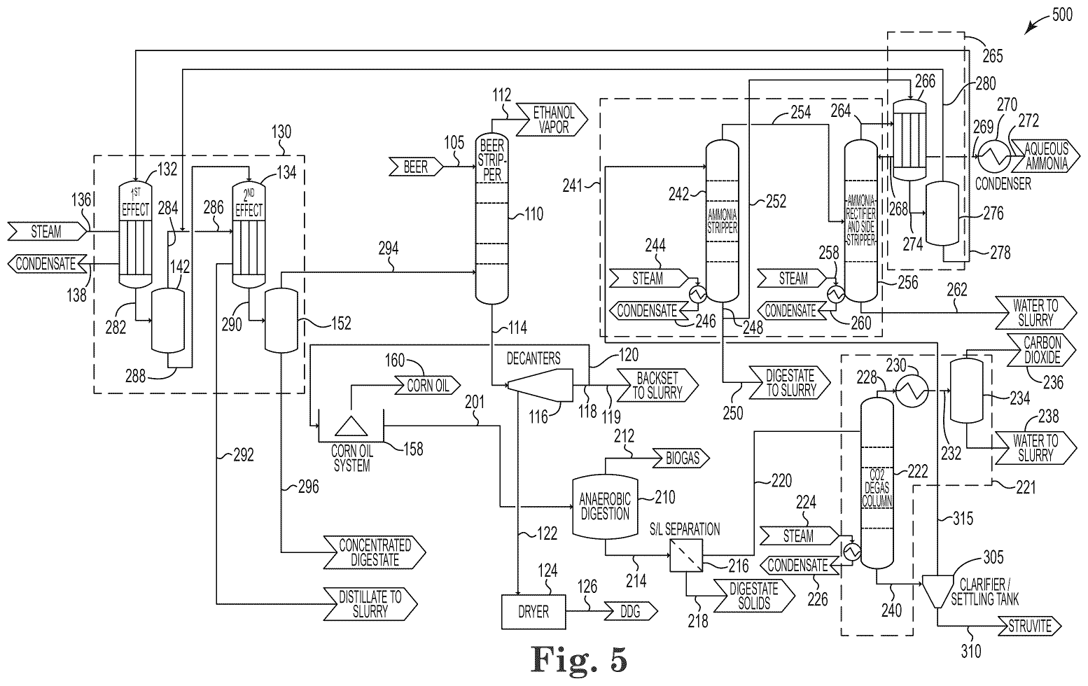

FIG. 5 shows another alternative bioprocessing facility 500 that incorporates anaerobic digestion. Bioprocessing facility 500 is similar to bioprocessing facility 200 in FIG. 2, described above, except that except that a mineral removal process is included after the carbon-dioxide degasification system 221, and wet cake 122 is dried in dryer system 124 to produce dried distillers' grain (DDG) 126 instead of being sent to mix tank 205 and anaerobic digestion system 210.

What is claimed is:

1. A bioprocessing facility comprising:
a source of one or more stillage compositions;
an anaerobic digestion system configured to receive and digest at least a portion of the one or more stillage compositions to produce a biogas and an anaerobic digestion digestate composition, wherein the anaerobic digestion digestate composition comprises a first concentration of ammonia;
an ammonia distillation system in fluid communication with at least a portion of the anaerobic digestion digestate composition, wherein the ammonia distillation system is configured to form at least a first concentrated anaerobic digestion digestate composition comprising a second concentration of ammonia that is less than the first concentration of ammonia, and a vapor composition comprising ammonia;
at least one evaporator, wherein the at least one evaporator is configured to receive at least a portion of the vapor composition from the ammonia distillation system as a heat source to heat a feed in the at least one evaporator and form a vapor composition and a concentrated liquid; and
a distillation system configured to receive at least a portion of thermal energy directly or indirectly from the vapor composition produced by the at least one evaporator to heat at least a portion of contents in the distillation system, wherein the distillation system is configured to separate at least one biochemical from a fermented composition.

2. The bioprocessing facility of claim 1, further comprising at least a first evaporator system and a second evaporator system,
wherein the first evaporator system comprises the at least one evaporator, wherein the at least one evaporator is configured to receive at least a portion of the first concentrated anaerobic digestion digestate composition as the feed to form the vapor composition and a second concentrated anaerobic digestion digestate composition as the concentrated liquid;
wherein the second evaporator system is a multi-effect evaporator system comprising at least a first-effect evaporator, a second-effect evaporator, and a final-effect evaporator, wherein the second-effect evaporator is configured to receive at least a portion of the vapor composition from the at least one evaporator as a heat source to heat a feed in the second-effect evaporator and form a vapor composition and a concentrated liquid; and
wherein the distillation system is configured to receive at least a portion of a vapor composition from the final-effect evaporator in the multi-effect evaporator system as a heat source to heat at least a portion of contents in the distillation system.

3. The bioprocessing facility of claim 2, wherein the second-effect evaporator is the final-effect evaporator.

4. The bioprocessing facility of claim 1, further comprising a separation system in fluid communication with the anaerobic digestion digestate composition from the anaerobic digestion system, wherein the separation system is configured to separate the anaerobic digestion digestate composition into at least an anaerobic digestion liquid effluent and an anaerobic digestion solid effluent, wherein the anaerobic digestion liquid effluent comprises a third concentration of ammonia, wherein an ammonia distillation system in fluid communication with at least a portion of the anaerobic digestion liquid effluent as the anaerobic digestion digestate composition, and wherein the second concentration of ammonia is less than the third concentration of ammonia.

5. The bioprocessing facility of claim 1, wherein the one or more stillage compositions comprise concentrated thin stillage from a dry-grind corn ethanol bioprocessing facility.

6. The bioprocessing facility of claim 5, further comprising a separator system in fluid communication with the concentrated thin stillage, wherein the separation system is configured to separate corn oil form the concentrated thin stillage prior to the anaerobic digestion system.

7. The bioprocessing facility of claim 5, wherein the anaerobic digestion system is configured to also receive and digest at least a portion of wet cake from a dry-grind corn ethanol bioprocessing facility.

8. The bioprocessing facility of claim 7, further comprising a mix tank configured to receive and mix the wet cake and the concentrated thin stillage prior to the anaerobic digestion system.

9. A method of producing biogas from one or more stillage compositions, wherein the method comprises:
exposing at least a portion of at least one stillage composition to anaerobic digestion conditions to produce a biogas and an anaerobic digestion digestate composition, wherein the anaerobic digestion digestate composition comprises a first concentration of ammonia;
introducing at least a portion of the anaerobic digestion digestate composition as feed into an ammonia distillation system to form at least a first concentrated anaerobic digestion digestate composition and a vapor composition, wherein the first concentrated anaerobic digestion digestate composition comprises a second concentration of ammonia that is less than the first concentration of ammonia, and wherein the vapor composition comprises ammonia;
introducing at least a portion of the vapor composition from the ammonia distillation system into at least one evaporator as a heat source to heat a feed in the at least one evaporator and form a vapor composition and a concentrated liquid; and
using at least a portion of thermal energy in the vapor composition produced by the at least one evaporator to heat at least a portion of contents in a distillation system, wherein the distillation system is configured to separate at least one biochemical from a fermented composition.

10. The method of claim 9, further comprising:
introducing the at least a portion of the first concentrated anaerobic digestion digestate composition into a first evaporator system as feed into the at least one evaporator to form the vapor composition and a second concentrated anaerobic digestion digestate composition as the concentrated liquid, wherein the first evaporator system comprises the at least one evaporator;
introducing at least a portion of the vapor composition from the at least one evaporator in the first evaporator system into a second evaporator system as a heat source, wherein the second evaporator system is a multi-effect evaporator system comprising at least a first-effect evaporator, a second-effect evaporator, and a final-effect evaporator, wherein the vapor composition from the at least one evaporator in the first evaporator system is introduced into the second-effect evaporator to heat a feed in the second-effect evaporator and form a vapor composition and a concentrated liquid; and
introducing at least a portion of a vapor composition from the final-effect evaporator into a distillation system as a heat source to heat at least a portion of contents in the distillation system.

11. The method of claim 10, further comprising:
introducing at least a portion of the second concentrated anaerobic digestion liquid effluent as feed into the first-effect evaporator of the second evaporator system to form a vapor composition and a third concentrated anaerobic digestion digestate composition; and
introducing at least a portion of the vapor composition from the first-effect evaporator, in addition to the vapor composition from the at least one evaporator in the first evaporator system, into the second-effect evaporator as the heat source.

12. The method of claim 11, wherein the second-effect evaporator is the final-effect evaporator.

13. The method of claim 11, further comprising introducing at least a portion of the third concentrated anaerobic digestion digestate composition as feed into the second-effect evaporator to form the vapor composition and a fourth concentrated second-effect evaporator as the concentrated liquid.

14. The method of claim 9, further comprising separating at least a portion of an anaerobic digestion liquid effluent from the anaerobic digestion digestate composition, wherein the anaerobic digestion liquid effluent comprises a third concentration of ammonia, wherein the anaerobic digestion liquid effluent is introduced into the ammonia distillation system as the anaerobic digestion digestate composition, and wherein the second concentration of ammonia is less than the third concentration of ammonia.

15. The method of claim 9, wherein the at least one stillage composition is derived from a grain feedstock, and further comprising separating at least a portion of grain oil from the at least one stillage composition prior to exposing at least a portion of at least one stillage composition to anaerobic digestion conditions.

16. The method of claim 9, wherein the ammonia distillation system further forms a liquid aqueous composition.

17. The method of claim 9, wherein at least a portion of the vapor composition from the ammonia distillation system that is introduced into the at least one evaporator as a heat source is condensed into a condensate comprising aqueous ammonia.

18. The method of claim 17, further comprising recycling at least a portion of the condensate to the ammonia distillation system.

19. The method of claim 9, wherein at least a portion of the vapor composition from the ammonia distillation system that is introduced into the at least one evaporator as a heat source is condensed into a first condensate, wherein a remaining portion of the vapor composition is not condensed;
wherein at least a portion of the first condensate is recycled to the ammonia distillation system; and
wherein at least a portion of the remaining portion of the vapor composition is introduced into a condenser and condensed into a second condensate.

20. The method of claim 9, wherein the anaerobic digestion digestate composition is separated into at least the anaerobic digestion liquid effluent and an anaerobic digestion solid effluent.
